(19) United States
(12) Patent Application Publication
(10) Pub. No.: US 2025/0295073 A1
(43) Pub. Date: Sep. 25, 2025

(54) VEHICLE POWER TRANSMISSION UNIT

(71) Applicant: KANZAKI KOKYUKOKI MFG. CO., LTD., Amagasaki-shi (JP)

(72) Inventors: Koji KIYOOKA, Amagasaki-shi (JP); Jun MATSUURA, Amagasaki-shi (JP); Mai TERADA, Amagasaki-shi (JP)

(21) Appl. No.: 19/088,022

(22) Filed: Mar. 24, 2025

(30) Foreign Application Priority Data
Mar. 25, 2024 (JP) 2024-047629

(51) Int. Cl. A01D 69/02; A01D 69/10; A01D 101/00; H02K 7/00; H02K 7/116

(52) U.S. Cl. CPC A01D 69/02; A01D 69/10; H02K 7/003; H02K 7/006; H02K 7/116; A01D 2101/00

(57) ABSTRACT

[Problem] Mountability of the vehicle power transmission unit, in which the brake unit is disposed on the side opposite to the electric travel motor in the housing, on the vehicle is improved.

[Solution] A power transmission unit 41 includes an electric travel motor 30, an input shaft, a gear mechanism 80a, and a housing 44. Power from the motor is transmitted to the input shaft, gear mechanism, and axle in sequence. A brake unit 90 is mounted on the housing opposite the motor and connected to the second end of the input shaft 60. A recess 60d is formed at the first end of the input shaft, into which the motor shaft 32 is inserted, with a power transmission part 33, 62 interposed between the recess and the motor shaft end.

### CROSS REFERENCE TO RELATED APPLICATIONS

The present invention claims priority under 35 U.S.C. § 119 to Japanese Application No. 2024-047629, filed on Mar. 25, 2024, the entire contents of which being incorporated herein by reference.

### TECHNICAL FIELD

The present invention relates to a vehicle power transmission unit.

### BACKGROUND ART

Conventionally, it has been known that a vehicle such as a lawn mowing vehicle can travel by using an electric travel motor to drive wheels. The lawn mowing vehicle includes a work unit such as a lawn mower. A lawn mowing vehicle in which left and right wheels are driven by a common electric travel motor is described in Patent Document 1. The following lawn mowing vehicle is described in Patent Document 2. In the lawn mowing vehicle, left and right wheels can be driven independently of each other, the left wheel is driven by a left electric travel motor, and the right wheel is driven by a right electric travel motor.

### PRIOR ART DOCUMENT

### Patent Document

Patent Document 1: U.S. Patent Application Publication No. 2009/0069964

Patent Document 2: Japanese Unexamined Patent Application Publication No. 2014-117026

### SUMMARY OF INVENTION

### Technical Problem

In the vehicle in which the left and right wheels are driven by one or two motors as described above, a power transmission unit is used to transmit power of the electric travel motor to the wheels. In this power transmission unit, it is considered that the power of the electric travel motor is transmitted to an input shaft, a gear mechanism, and an axle in this order, and a brake unit for braking the wheels is disposed on a side opposite to the electric travel motor in a housing. Further, it is also considered that a motor shaft of the electric travel motor and the input shaft to which a brake rotor is fixed are arranged such that axes thereof align with each other, and a shaft coupling is connected to outer circumferential sides of mutually opposed ends of the motor shaft and the input shaft by spline engagement.

However, in this case, since a fitting portion is divided into two in an axial direction via a coupling between the motor shaft and the input shaft, the length from an end surface of the electric travel motor on the housing side to an outer surface of the brake unit is increased. As a result, there is room for improvement in terms of improving mountability of the vehicle power transmission unit on the vehicle.

The invention aims to improve mountability of the vehicle power transmission unit, in which the brake unit is disposed on the side opposite to the electric travel motor in the housing, on the vehicle.

### Solution to Problem

A power transmission unit includes an electric travel motor, an input shaft having a first end and second end, a gear mechanism, and a housing, and power from the electric travel motor is transmitted to the input shaft, the gear mechanism, and an axle in this order, a brake unit is mounted to the housing on a side opposite to the electric travel motor and is connected to the second end of the input shaft, a recess is formed in an end surface of the first end of the input shaft on the electric travel motor side, an end of the motor shaft on the input shaft side is inserted into the recess, and a power transmission part interposed between the recess and the end of the motor shaft.

### Advantageous Effects of Invention

According to the vehicle power transmission unit according to the present invention, in the configuration in which the brake unit is disposed on the side opposite to the electric travel motor in the housing, a length from a housing side end surface of the electric travel motor to an outer surface of the brake unit can be shortened. As a result, mountability of the vehicle power transmission unit on the vehicle can be enhanced.

### BRIEF DESCRIPTION OF DRAWINGS

FIG. 1 is a perspective view of a vehicle equipped with a vehicle power transmission unit according to an embodiment of the present invention;

FIG. 2 is a schematic configuration view of the vehicle in FIG. 1 that is seen from above;

FIG. 3 is a top view of a power transmission structure for left and right wheels including left and right power transmission units illustrated in FIG. 2;

FIG. 4A is a transverse cross-sectional view of a left power transmission unit illustrated in FIG. 3;

FIG. 4B is an enlarged view of a front portion in FIG. 4A;

FIG. 5 is a cross-sectional view along A-A in FIG. 4B;

FIG. 6 is a view illustrating a brake unit and a spacer separated from other components in FIG. 4B;

FIG. 7 is a diagram corresponding to FIG. 6 in another example of an embodiment of the invention;

FIG. 8 is a diagram corresponding to FIG. 6 in another example of an embodiment of the invention;

FIG. 9 is a diagram corresponding to a B-B cross section in FIG. 5 in another example of the embodiment of the invention;

FIG. 10 is a diagram corresponding to FIG. 4B in another example of an embodiment of the invention;

FIG. 11 is a diagram corresponding to FIG. 9 in another example of the embodiment of the invention; and

FIG. 12 is a diagram corresponding to FIG. 9 in another example of an embodiment of the invention.

FIG. 13 is a diagram corresponding to FIG. 4B in another example of an embodiment of the present invention.

FIG. 14 is a diagram corresponding to the C-C cross-section of FIG. 13.

FIG. 15 is an operational explanatory diagram in Embodiment 3 of the present invention.

FIG. 16 is a diagram corresponding to the D-D cross-section of FIG. 15.

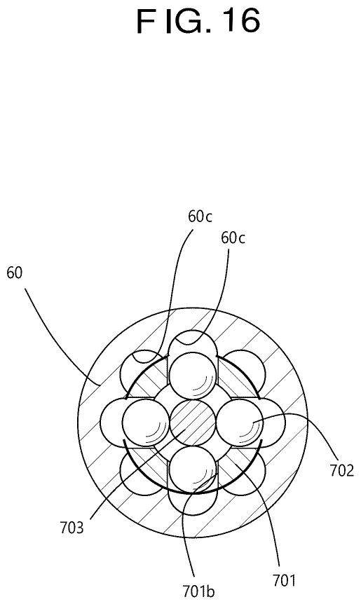

### DESCRIPTION OF EMBODIMENTS

Hereinafter, an embodiment of the present invention is described in detail with reference to the drawings. Hereinafter, a case where a vehicle power transmission unit is mounted on a lawn mowing vehicle as a work vehicle is described. However, a vehicle on which the vehicle power transmission unit is mounted is not limited thereto and may be another work vehicle having a work unit for performing at least one of snow removal work, excavation work, construction work, and agricultural work, an off-road utility vehicle having a luggage carrier and traveling on an uneven terrain, an all-terrain vehicle (ATV), a recreational vehicle (RV), or a recreational off-highway vehicle (ROV). In addition, in the following description, a case where two rear wheels are driven by two motors in the vehicle will be described, but the vehicle may have a configuration in which two front wheels are driven by two motors. Further, in the following description, a case where two left and right operation levers are respectively configured as a turning instruction tool and a traveling instruction tool will be described, but this is an only example, and a steering wheel may be used as the turning instruction tool, and an accelerator pedal provided on a front side of a seat may be used as the traveling instruction tool. In the following, the same components are denoted by the same reference numerals in all of the drawings, and redundant description will be omitted or simplified.

### First Embodiment

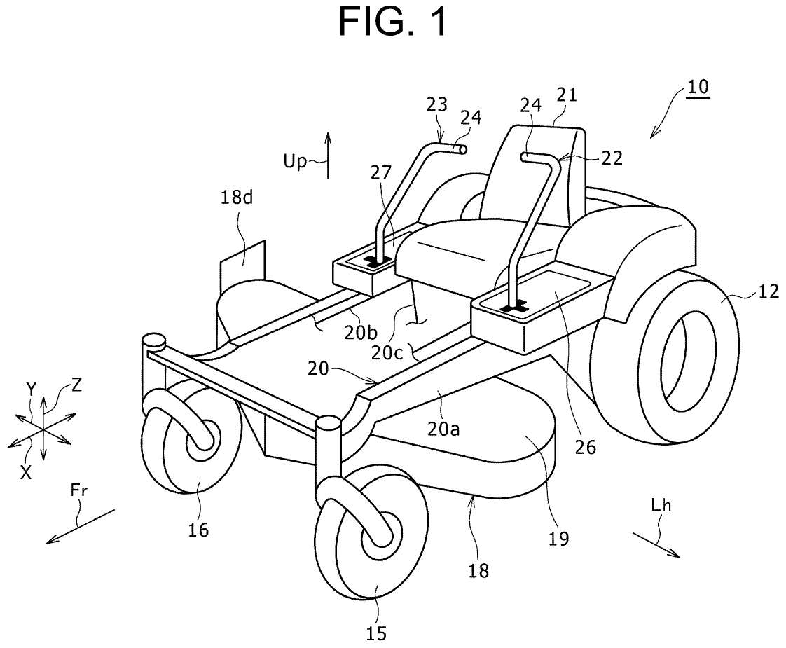

FIGS. 1 to FIG. 6 illustrate a first embodiment. In the drawings described below, a front-rear direction is denoted by X, a left-right direction is denoted by Y, and an up-down direction is denoted by Z. Further, a front side is denoted by Fr, a left side is denoted by Lh, and an upper side is denoted by Up. The directions X, Y, Z are orthogonal to each other.

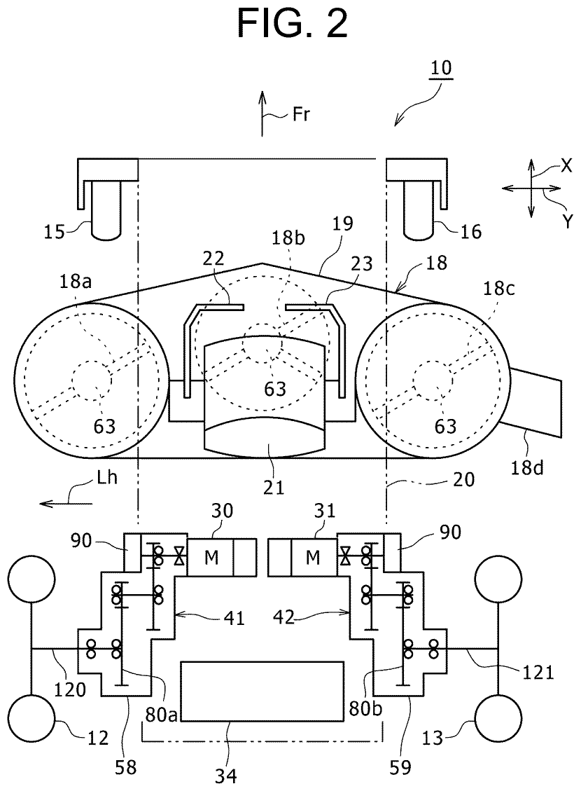

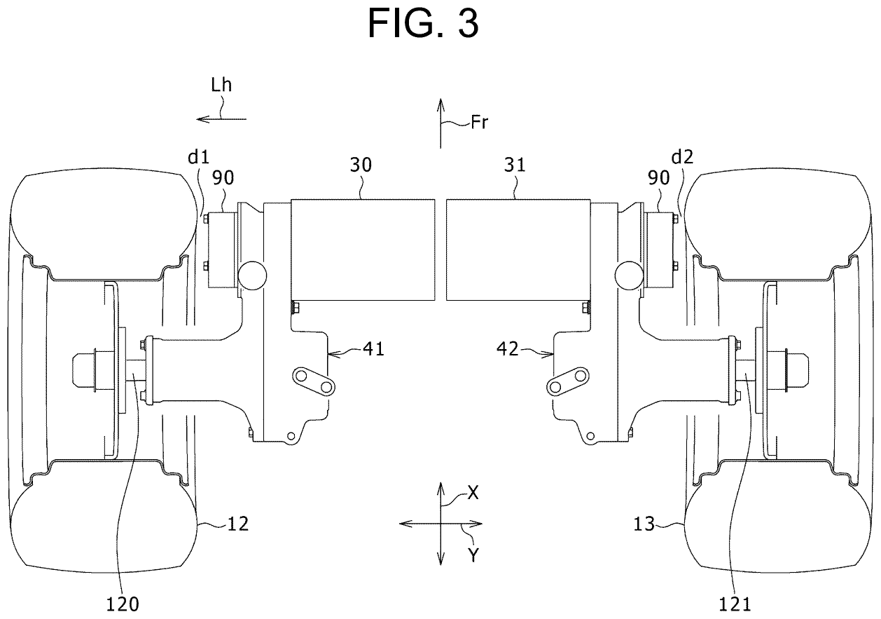

FIG. 1 is a perspective view of a vehicle 10 in which a vehicle power transmission unit according to the embodiment is incorporated. FIG. 2 is a schematic configuration view of the vehicle 10. FIG. 3 is a top view of a power transmission structure for left and right wheels 12, 13 including left and right power transmission units illustrated in FIG. 2. In the following description, the vehicle power transmission unit is referred to as a power transmission unit. The vehicle 10 is a passenger self-propelled lawn mowing vehicle suitable for lawn mowing. The vehicle 10 includes: two left and right wheels that are a left wheel 12 and a right wheel 13 (FIG. 2 and FIG. 3); caster wheels 15, 16 as two left and right front wheels; a lawn mower 18 as a work unit; and a left electric travel motor 30 and a right electric travel motor 31 (FIG. 2 and FIG. 3). The vehicle 10 also includes three deck motors 63 (FIG. 2) as work motors, two left and right operation levers 22, 23, a battery 34 (FIG. 2), and a controller (not illustrated). The deck motors 63 is an electric motor.

The left wheel 12 and the right wheel 13 are rear wheels supported on both left and right sides of a rear side of a main frame 20 which is a vehicle body and are main driving wheels. The main frame 20 is formed of metal, such as a steel material, into a beam structure or the like. The main frame 20 includes: side plate sections 20a, 20b that respectively extend in the substantially front-rear direction at left and right ends; and a coupling portion 20c that couples the side plate sections 20a, 20b on the left and right sides. Between rear end portions of the left and right side plate portions 20a and 20b, a driver's seat 21 on which a driver as an operator sits is fixed at an upper side.

The operation levers 22, 23 are arranged on left and right sides of the driver's seat 21 and instruct a rotation direction and rotation speed of the left wheel 12 or the right wheel 13 at a corresponding side by operation in the front-rear direction, respectively. Specifically, in the main frame 20, two guide panels 26 and 27 are fixed at both of left and right sides of the driver's seat 21, and the two operation levers 22 and 23 at left and right are supported on the main frame 20 such that each of the two operation levers 22 and 23 projects upward from a corresponding one of the two guide panels 26 and 27. Each operation lever 22, 23 is configured to be swingable back and forth about a support shaft along the left-right direction at a lower end (not illustrated) thereof.

The left operation lever 22 corresponds to a travel instruction tool for instructing acceleration/deceleration, stop, and normal/reverse rotation of the left electric travel motor 30, and the right operation lever 23 corresponds to a traveling instruction tool for instructing acceleration/deceleration, stop, and normal/reverse rotation of the right electric travel motor 31. A grip portion 24 extending in the left-right direction is formed at a tip of each of the operation levers 22 and 23 and is gripped by the driver in order to instruct a rotation direction and a rotation speed of the left wheel 12 and the right wheel 13. As for each of the operation levers 22 and 23, when the operation lever 22 (or 23) is tilted forward using as a reference an N position that is a neutral position near an upright position, the operation lever 22 (or 23) instructs to drive the electric travel motor 30 (or 31) at a same side as the operation lever 22 (or 23) at a target rotation number per unit time (sec-1) that is a target rotation speed corresponding to forward traveling. As the target rotation speed, a target rotation number per minute (min-1) may be set.

The target rotation number of the wheels 12, 13 is configured to increase as a tilting amount of the operation levers 22, 23 increases (the grip portion 24 moves away from an N position). When being tilted rearward with reference to N position, the operation levers 22, 23 each instruct to drive the electric travel motor 30 (or 31) on the same side as the operation lever 22 (or 23) at the target rotation number corresponding to reverse travel. When being moved to the N position, the operation lever 22 (or 23) instructs to stop driving of the electric travel motor 30 (or 31) on the same side. In this way, when being operated by the driver, the operation levers 22, 23 respectively instruct the target rotational frequencies of the electric travel motors 30, 31 and thereby instruct forward travel, backward travel, or stopping of the vehicle.

Tilted positions of the operation levers 22, 23 in the front-rear direction are detected by left and right lever position sensors (not illustrated), respectively. An example of the lever position sensor includes a potentiometer. Thus, the instruction of each of the operation levers 22 and 23 is transmitted to a controller (not illustrated) as a detection signal.

Caster wheels 15, 16 are steered wheels supported on a front end portion of the main frame 20 and also serve as front wheels. The caster wheels 15, 16 are provided so as to be spaced apart from the left wheel 12 and the right wheel 13 in the front-rear direction of the vehicle 10. Each of the caster wheels 15, 16 is capable of free rotation of 360 degrees or more about a shaft extending in the vertical direction (up-down direction in FIG. 1). Note that the caster wheels are not limited to such a configuration where two caster wheels are arranged on a vehicle, and only one caster wheel or three or more caster wheels may be arranged on the vehicle.

As illustrated in FIG. 2, the left electric travel motor 30 is connected to the left wheel 12 via a left axle 120 and a left gear mechanism 80a that is supported on a rear portion of the main frame 20. The right electric travel motor 31 is connected to the right wheel 13 via a right axle 121 and a right gear mechanism 80b that is supported on a rear portion of the main frame 20. The left electric travel motor 30 and the right electric travel motor 31 are supported at the left side and the right side, respectively, at the rear side of the main frame 20. The electric travel motors 30, 31 drive and stop the wheels 12, 13 independently of each other according to an operation of respective operation levers 22, 23.

The left electric travel motor 30 is connected to a battery 34 (FIG. 2) via a left travel inverter (not illustrated) and is supplied with electric power from the battery 34. The right electric travel motor 31 is connected to a battery 34 via a right travel inverter (not illustrated) and is supplied with electric power from the battery 34. The left electric travel motor 30 and the right electric travel motor 31 are, for example, three-phase motors.

As illustrated in FIG. 2, the battery 34 is disposed in an appropriate space of the main frame 20 behind the driver's seat 21 in consideration of a center of gravity of the vehicle.

As illustrated in FIG. 1 and FIG. 2, a lawn mower 18 is supported on a lower side of a longitudinally intermediate portion of the main frame 20. Thus, the lawn mower 18 is disposed so as to mow grass between the caster wheels 15, 16 and the left and right wheels 12, 13 in the front-rear direction. The lawn mower 18 includes three lawn mowing blades 18a, 18b, 18c (FIG. 2) as rotary lawn mowing devices that are arranged inside a mower deck 19 as a cover. Upper sides of the lawn mowing blades 18a, 18b, and 18c are covered by the mower deck 19. Each of the lawn mowing blades 18a, 18b, and 18c includes a plurality of blade elements that rotate around a shaft oriented in the vertical direction (paper front-back direction of FIG. 2). As a result, the blade elements rotate and cut a lawn to mow the lawn. A mowed lawn is discharged to the outside from a discharge duct 18d provided at one side of the mower deck 19 in the left-right direction.

The lawn mowing blades 18a, 18b, and 18c are connected to the respective deck motors 63, which are work motors. Each of the deck motors 63 is connected to the battery 34 via a mowing inverter (not illustrated) for the respective deck motor 63, and power is supplied or stopped from the battery 34 to the deck motor 63 simultaneously. Each of mowing inverters is controlled by the controller according to an operation of a mowing switch (not illustrated) near the driver's seat. In this way, each of the deck motors 63 is driven. Each of the deck motors 63 is, for example, the three-phase motor.

The lawn mower may be configured to include, as another example of a rotary lawn mowing tool, a lawn mowing reel that includes, for example, a spiral blade arranged around a rotation shaft parallel to a ground surface, has a function of mowing a lawn or the like, and is driven by a deck motor.

Furthermore, the two operation levers 22, 23 are supported to be able to tilt from an upright neutral position to open laterally outward in a vehicle width direction, in which an outward tilted position is defined as a parking brake position. The operation levers 22, 23 instruct actuation of a parking brake when both of the operation levers 22, 23 move to the parking brake positions. A T-shaped guide groove may be formed in guide panels 26, 27 provided in an upper portion of the vehicle to guide movement of the operation levers 22, 23 outward in the vehicle width direction.

The respective left and right operation levers 22,23 are mechanically or electrically connected to brake units 90 provided in the power transmission units 41, 42, which will be described later. By moving the operation levers 22, 23 to the parking brake positions, the respective brake units 90 are operated to brake the left wheel 12 and the right wheel 13.

The overall configuration of the vehicle 10 has been described so far. Next, the left and right power transmission units 41, 42 (FIG. 2 and FIG. 3) mounted on this vehicle 10 will be described. The left power transmission unit 41 is connected to the left wheel 12, and the right power transmission unit 42 is connected to the right wheel 13. The right power transmission unit 42 and the left power transmission unit 41 are configured symmetrically with respect to a center in the vehicle width direction. Thus, a detailed description will hereinafter be made on the left power transmission unit 41. Hereinafter, the left electric travel motor 30 mounted on the left power transmission unit 41 will be referred to as an electric travel motor 30.

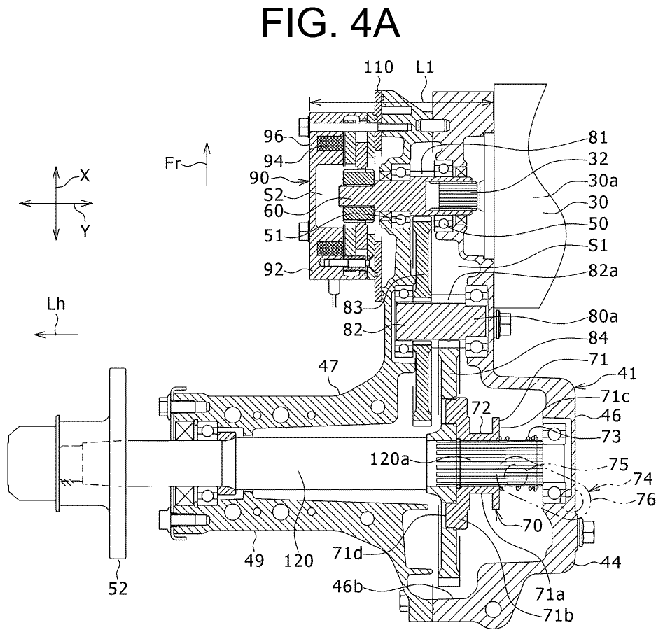

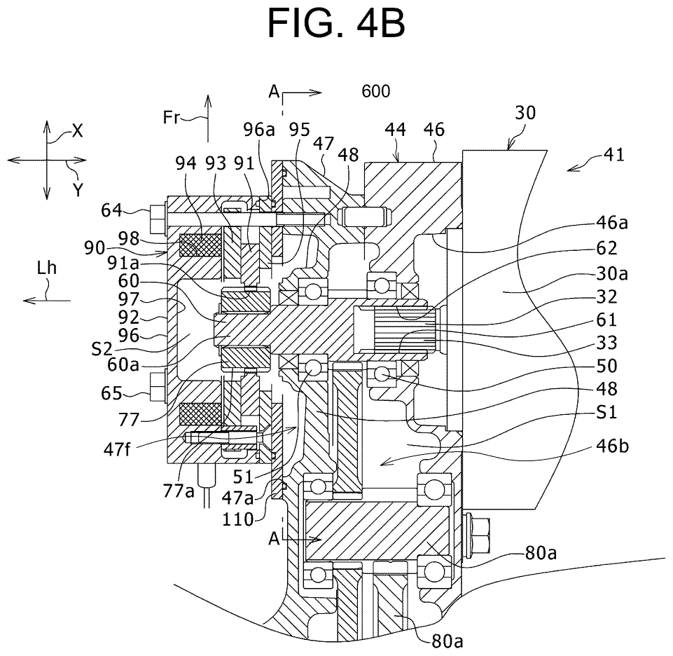

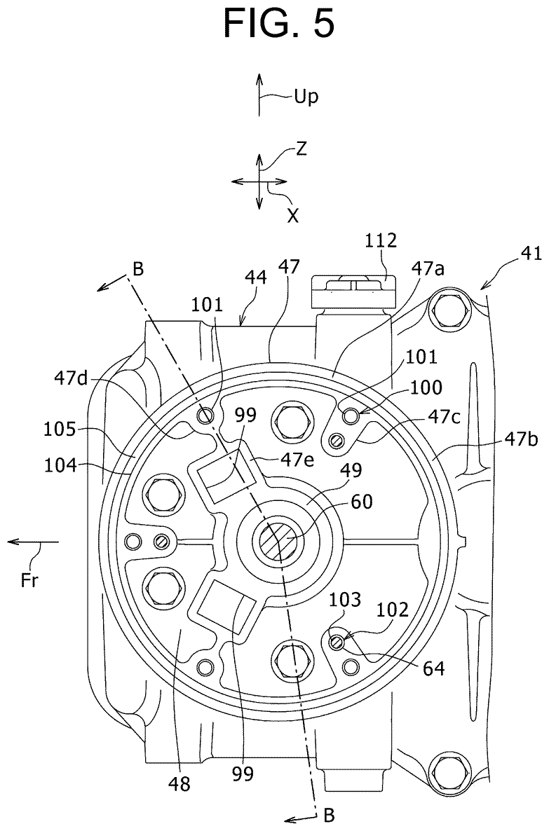

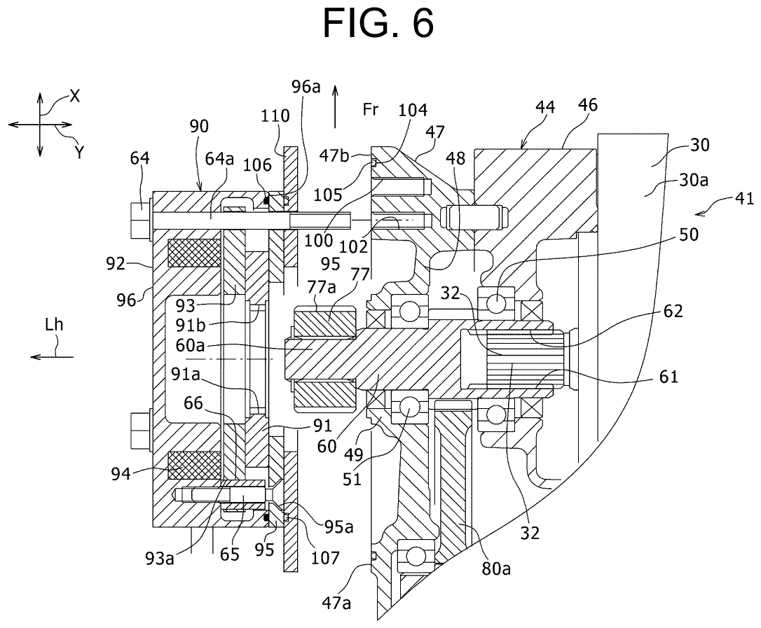

FIG. 4A is a transverse cross-sectional view of the left power transmission unit 41. FIG. 4B is an enlarged view of a front portion in FIG. 4A. FIG. 5 is a cross-sectional view along A-A in FIG. 4B. FIG. 6 is a view illustrating a brake unit 90 and a spacer 110 separated from other components in FIG. 4B. The power transmission unit 41 is formed by integrally combining a housing 44 which is a transmission case, the electric travel motor 30, the gear mechanism 80a, an axle 120, a spacer 110, and the brake unit 90.

The housing 44 accommodates the input shaft 60, the axle 120, and the gearing mechanism 80a. The gear mechanism 80a transmits power between the input shaft 60 and the axle 120 and transmits rotational power from the input shaft 60 to the axle 120 at a reduced speed. The input shaft 60 and the axle 120 are arranged in parallel. The input shaft 60 is connected to a motor shaft 32 of the electric travel motor 30 and rotates in synchronization with the motor shaft 32.

The housing 44 is integrated by coupling a first member 46 facing inward in the vehicle width direction (a right side of a paper surface of FIG. 4A), which is one side in an axial direction, and a second member 47 facing outward in the vehicle width direction (a left side of the paper surface of the FIG. 4A), which is the other side in the axial direction, with a plurality of bolts. Note that the axial direction of the power transmission unit 41 is a direction along the input shaft 60 and the axle 120 and aligns with the vehicle width direction.

The first member 46 is a gear case half portion and has an opening 46a on the front side of a sidewall facing inward in the vehicle width direction. The sidewall facing outward in the vehicle width direction has an opening 46b that is a joint surface to the second member 47 and extends from the front side to the rear side.

The second member 47 is a gear case half portion, has an opening in a peripheral wall facing inward in the vehicle width direction that is a joint surface to the first member 46 and extends from the front side to the rear side. A cylindrical portion 49 extends along the axial direction on the rear side of the side wall facing outward in the vehicle width direction. The axle 120 is accommodated in the cylindrical portion 49 and protrudes to the outside of the case. The opening 47f concentric with the opening 46a is provided on the front side of the sidewall facing outward in the vehicle width direction.

The housing 44 is formed by joining the first member 46 and the second member 47 such that the joint surfaces thereof abut each other. As a result, a gear chamber S1 is formed, in which the gear mechanism 80a is disposed. On the other hand, the opening 46a is covered by a motor case 30a of the electric travel motor 30. The motor shaft 32 of the electric travel motor 30 and the input shaft 60 are arranged in a facing manner such that axes thereof align with each other.

The input shaft 60 is rotatably supported by bearings 50, 51 and respectively held in the opening 46a of the first member 46 and the opening 47f of the second member 47. A first end of the input shaft 60 facing the electric travel motor 30 side faces the opening 46a and is located at a position extending inward in the vehicle width direction from the bearing 50.

A cylindrical recess 60d is formed in an end surface of the first end of the input shaft 60. The recess 60d is formed in a shaft spline hole 61 having a female spline portion 62 on an inner peripheral surface thereof.

A shaft end of the motor shaft 32 facing the input shaft 60 side is inserted into the shaft spline hole 61. A male spline portion 33 that is spline-engaged with the female spline portion 62 is formed on an outer peripheral surface of the shaft end. Each of the spline portions 62 and 33 is a power transmission part, and key or ball may be used instead. Thus, both shafts 60 and 32 are directly connected so as not to be relatively rotated without using a coupling.

A second end 60a of the input shaft 60, which is located on the side opposite to the connection side of the electric travel motor 30, faces the opening 47f and extends outward in the vehicle width direction from the bearing 51. A brake rotor 91 (FIGS. 4A, FIG. 4B, and FIG. 6) constituting a brake unit 90, which will be described later, is connected to the second end 60a of the input shaft 60 and is provided so as not to be rotatable relative to the input shaft 60.

A brake case 92 constituting the brake unit 90 is mounted by a plurality of bolts 64 to a sidewall of the second member 47 facing outward in the vehicle width direction so as to cover the second end 60a of the input shaft 60 and the brake rotor 91. As a result, the brake unit 90 closes the opening 47f of the second member 47 and is disposed on the opposite side to the electric travel motor 30 in the housing 44. The electric travel motor 30 generates heat by being driven. The brake unit 90 also generates heat by being operated. Therefore, it is possible to facilitate the heat dissipation of each of them by arranging them at positions far from each other. A brake chamber S2 (FIG. 4A and FIG. 4B) is formed inside the brake case 92.

The gear mechanism 80a includes a first helical gear 81 formed directly on the input shaft 60, an intermediate gear shaft 82 disposed between the input shaft 60 and the axle 120 and having an outer circumferential surface on which a second helical gear 83 is engaged, and an output gear 84. The second helical gear 83 meshes with the first helical gear 81, and the output gear 84 meshes with teeth on one side of an intermediate gear portion 82a formed directly on the intermediate gear shaft 82.

Internal teeth of the second helical gear 83 mesh with teeth on the other side of the intermediate gear portion 82a. The intermediate gear shaft 82 and the axle 120 are each rotatably supported on the inner side of the housing 44 via a bearing.

As illustrated in FIG. 4A, an outer side portion of the axle 120 in the vehicle width direction protrudes outward from a tip of the cylindrical portion 49, and a hub 52 is fixed to the protruding portion of the axle 120. The left wheel 12 is fixed to the hub 52. Further, the output gear 84 constituting the gear mechanism 80a is relatively rotatably fitted to an outer circumferential surface on an inner side of the axle 120 in the vehicle width direction. The output gear 84 receives power for driving the wheel from the electric travel motor 30 via the gear mechanism 80a. On an outer circumferential surface of an intermediate portion of the axle 120 located inside the housing 44, a clutch slider 71 that constitutes a clutch mechanism 70 is externally fitted to a position adjacent to an inner end in the vehicle width direction of the output gear 84.

The clutch mechanism 70 is configured to include the output gear 84, the axle 120, the clutch slider 71, and a lever member 74. A male spline portion 120a is formed on the outer circumferential surface of the intermediate portion of the axle 120. On the other hand, the clutch slider 71 has a cylindrical portion 71a and a pair of flanges 71b, 71c provided on outer circumferential surfaces of both ends of the cylindrical portion 71a, and a locking groove 72 is formed over the entire circumference in a portion surrounded by side surfaces of the pair of flanges 71b, 71c and the outer circumferential surface of the cylindrical portion 71a.

Further, a female spline portion formed on an inner circumferential surface of the cylindrical portion 71a is spline-engaged with a male spline portion 120a of the axle 120. In this way, the clutch slider 71 is fitted to the axle 120 in a manner not to rotate relative thereto and to be freely slidable in the axial direction. A recesses 71d are formed at a plurality of circumferential positions on an outer end surface of a flange 71b on the output gear 84 side of the clutch slider 71. The plurality of recesses 71d can be engaged with recesses (through holes) formed at a plurality of circumferential positions on the output gear 84 by axial movement of the clutch slider 71.

The lever member 74 includes a lever shaft 75 extending in the up-down direction and an arm portion (not illustrated) extending in a direction orthogonal to the lever shaft 75 at a lower end of the lever shaft 75. The lever shaft 75 is rotatably supported by the first member 46, and an upper end of the lever shaft 75 protrudes outward from an outer surface of the first member 46. The arm portion is locked to the locking groove 72 of the clutch slider 71.

An operation arm 76 is fixed to the lever shaft 75 protruding from the first member 46. A clutch switching instruction portion (not illustrated) such as a lever provided near a driver's seat in the vehicle is connected to the operation arm 76 via a wire or a link. When the clutch slider 71 moves outward in the vehicle width direction with respect to the axle 120 in response to an operation of the clutch switching instruction portion, the recess 71d of the clutch slider 71 is engaged with the recess of the output gear 84, and the clutch mechanism 70 is brought into the engaged state. In this engaged state, the power of the electric travel motor 30 is transmitted from the motor shaft 32 to the input shaft 60, is reduced in speed at the gear mechanism 80a, and is transmitted to the axle 120 via the clutch mechanism 70. Consequently, the left wheel 12 rotates.

On the other hand, when the clutch slider 71 moves inward in the vehicle width direction with respect to the axle 120 in response to an operation of the clutch switching instruction portion, the recess 71d of the clutch slider 71 is pulled out from the recess of the output gear 84, the clutch mechanism 70 is disconnected, and the axle 120 becomes freely rotatable.

A coil spring 76 is provided between the clutch slider 71 and a retaining ring that is locked to an inner end of the axle 120 in the vehicle width direction. The clutch slider 71 is biased by the coil spring 76 in a direction in which the clutch mechanism is engaged.

The electric travel motor 30 includes a motor rotor that is fixed to an outer circumferential surface of the motor shaft 32, a stator core that opposes an outer circumferential surface of the motor rotor, and a three-phase stator coil that is wound around the stator core. The motor rotor has permanent magnets that are arranged at plural circumferential positions on the rotor core, for example. The stator core is fixed to the inner side of the motor case 30a.

The motor shaft 32 is rotatably supported on the motor case 30a by a bearing (not illustrated). When three-phase alternating-current power is supplied to the stator coil from the battery, the motor shaft 32 rotates due to an interaction between a rotating magnetic field generated in the stator core and a magnetic field generated by the motor rotor.

Next, the brake unit 90 will be described with reference to FIGS. 4A to FIG. 6. A cylindrical sleeve 77 is fixed to the outside of the above-described second end 60a of the input shaft 60 in a relatively non-rotatable manner. Further, a female spline portion 91b is formed on an inner circumference of a hole 91a provided at a rotational center of the brake rotor 91. A male spline portion 77a is formed on an outer circumferential surface of the sleeve 77 and is spline-engaged with the female spline portion 91b of the brake rotor 91. As a result, the brake rotor 91 is not rotatable relative to the input shaft 60 but is movable in the axial direction.

The brake unit 90 is an electromagnetic brake unit that performs a brake engaging/disengaging operation by energizing and de-energizing an electromagnet 94. Specifically, the brake unit 90 includes the above-described brake rotor 91, the brake case 92, an armature 93 disposed such that the brake rotor 91 is interposed between the armature 93 and a lid plate 95 described later, and the electromagnet 94. In FIGS. 4A, FIG. 4B, and FIG. 6, the electromagnet 94 is illustrated in a simplified manner by a diagonal lattice portion.

The brake case 92 includes a case body 96, which has a bottomed cylindrical shape with an opening at an inner end in a vehicle width direction, and the lid plate 95 fixed to an inner end in the vehicle width direction of the case body 96 so as to cover an opening of the case body 96. A first recess 97 is formed at a center of an inner surface of the case body 96, and the second end 60a of the input shaft 60 faces the first recess 97. An annular second recess 98 is formed around the first recess 97 of the case body 96, and the electromagnet 94 is disposed in the second recess 98. The electromagnet 94 is an electromagnetic solenoid and is a coil. The lid plate 95 has a ring shape and is formed of a plate-shaped friction member such as a steel plate.

The armature 93 also has a ring shape and is formed of a plate-shaped friction member such as a steel plate. In the brake case 92, the armature 93 faces the electromagnet 94 in a non-energized state with a predetermined distance therebetween and is supported so as to be movable in the axial direction. The brake rotor 91 is disposed so as to face an inner surface of the armature 93 in the vehicle width direction.

The lid plate 95 is in close contact with the inner end surface 96a of the case body 96 in the vehicle width direction. The lid plate 95 is threaded to a brake attachment surface 47a, which is a part of the outer surface of the second member 47 in the vehicle width direction, with the bolts 64 via the spacer 110. The outer diameter of the brake attachment surface 47a is larger than the outer diameter of the case body 96. The outer diameter of the lid plate 95 is substantially equal to the outer diameter of the case body 96. The spacer 110 is formed of a thin plate-shaped member, and its outer diameter is set to be substantially equal to the brake attachment surface 47a. The spacer 110 functions as an interface of the brake unit 90 to the housing 44. As a result, when the lid plate 95 is mounted, the lid plate 95 protrudes radially outward over the entire circumference of the outer circumferential surface of the case body 96.

As illustrated in FIG. 6, through holes 95a through which the thread 65 passes are formed at a plurality of positions in the circumferential direction of the lid plate 95. In the through hole 95a, a conical surface portion is formed on the spacer side of the circular hole and engaged with the head portion of the thread 65. A plurality of through holes 95a to which a cylindrical sleeves 66 are fitted are formed at positions facing the plurality of through holes 93a at a plurality of positions in the circumferential direction of the armature 93. The armature 93 is axially slidable relative to the sleeve 66. The threads 65 pass through the inside of the sleeves 66 and are threaded into a plurality of thread holes formed in the bottom inner surface of the case body 96 of the brake case 92. At this time, the heads of the threads 65 are engaged with the through holes such that the lid plate 95 is fixed to the case body 96.

A plurality of bolts 64 are inserted from the outside of the brake case 92 so as to pass through the armature 93 and the lid plate 95 in the axial direction, and thread portions of the bolts 64 protrude inward in the vehicle width direction from the lid plate 95. Accordingly, the brake unit 90 can be separated from the input shaft 60 in a state where the electromagnet 94, the armature 93, and the brake rotor 91 are accommodated in and supported by the brake case 92. The protruding thread portion is fitted into the second thread hole group 102 opened in the outer surface in the vehicle width direction of the second member 47 of the housing 44.

In the power transmission unit 41 according to the present embodiment, components other than the brake unit 90 and the spacer 110 can be used in combination with any one of three types of brake units, i.e., two types of electromagnetic brake units having different sizes and a mechanical brake unit, as will be described later in detail. In this example, the brake unit 90, which is a small electromagnetic brake unit, is used in combination with the spacer 110.

As illustrated in FIG. 5, a first thread hole group 100 and the second thread hole group 102 are formed in the brake attachment surface 47a portion of the second member 47 of the housing 44 along the radial direction about the input shaft 60. The brake attachment surface 47a includes an annular portion 47b against which the outer circumferential portion of the inner side surface in the vehicle width direction of the spacer 110 can abut, and a plurality of first ribs 47c and a plurality of second ribs 47d connected to the inner circumferential side of an annular portion 47b. The plurality of first ribs 47c extend radially toward the inside diameter side of the annular portion 47b, and the plurality of second ribs 47d protrude toward the radially inner side of the annular portion 47b in a semi-circular shape in cross section. In the second member 47, the first rib 47c and the second rib 47d protrude from an outer surface in the vehicle width direction of a wall portion 48 that partitions the inside and outside in the vehicle width direction. In FIG. 5, the number of the plurality of first ribs 47c is three but may be two or four or more.

A substantially rectangular connection rib 47e that connects the second rib 47d and the cylindrical portion 49 is also formed on the radially inner side of the annular portion 47b. The connection rib 47e also protrudes from the outer surface in the vehicle width direction of the wall portion 48 of the second member 47. A holding recess 99 for holding the fixed brake pad is formed in an outer end surface of the connection rib 47e. The fixed brake pad is used when the above-described mechanical brake unit is employed.

A plurality of first holes 101 are formed in outer end surfaces of the plurality of first ribs 47c and the plurality of second ribs 47d at positions radially spaced apart from the input shaft 60 by a predetermined distance. Each of the plurality of first holes 101 is formed in each of the plurality of first ribs 47c and the plurality of second ribs 47d. The plurality of first holes 101 constitute a first thread hole group 100. Each of the plurality of first holes 101 is formed in a thread hole and is used when the large electromagnetic brake unit or the large mechanical brake unit is assembled. Each of the first holes 101 may be a simple cylindrical hole before a female thread is formed therein instead of a thread hole, and when the large electromagnetic brake unit or the large mechanical brake unit is mounted, a female thread may be formed in the cylindrical hole after the second member 47 is manufactured.

A plurality of second holes 103 are formed in the outer end surface of each of the plurality of first ribs 47c at positions radically spaced apart from the input shaft 60 by a predetermined distance and inside the first thread hole group 100. Each of the plurality of second holes 103 is formed in each of the plurality of first ribs 47c. The plurality of second holes 103 constitute a second thread hole group 102. Each of the plurality of second holes 103 is a thread hole and used when the small electromagnetic brake unit is assembled as in this example.

In FIGS. 4B and FIG. 6, the brake unit 90 is fixed to the second member 47 by selecting the second thread hole group 102 on the inner side from the first thread hole group 100 and the second thread hole group 102 and using a plurality of bolts 64 threaded to the second thread hole group 102.

At this time, the bolts 64 passing through the through holes provided at the plurality of positions of the brake case 92 pass through the armature 93, the lid plate 95, and the spacer 110 in the axial direction, and are threaded to the second thread hole group 102. Here, an intermediate shaft portion 64a of the bolts 64 of which outer circumferential surface is a cylindrical surface pass through the armature 93 so as to be axially slidable.

In FIG. 5, a common annular seal groove 104 is formed on a surface of the annular portion 47b so as to surround the first thread hole group 100 and the second thread hole group 102, and a seal member 105 such as an O-ring is disposed in the seal groove 104. When the brake case 92 is fixed to the second member 47, the seal member 105 is compressed between the spacer 110 and the seal groove 104.

A first thread hole group 100 is arranged along the circumferential direction inside the seal member 105, and a second thread hole group 102 is arranged along the circumferential direction inside the first thread hole group 100. Thus, the seal member 105 seals a portion between the brake case 92 and the second member 47 regardless of whether the large or small brake unit 90 is attached to the housing 44.

A seal groove 96a is provided in an end surface of the case body 96 such that a seal member 106 is disposed to seal a portion between the case body 96 and the lid plate 95. Similarly, a seal groove is provided on an end surface of the spacer 110 such that a seal member 107 is disposed to seal a portion between the spacer 110 and the lid plate 95.

The electromagnet 94 can attract the armature 93 when being energized. When the electromagnet 94 is not energized, the armature 93 presses the brake rotor 91 against the lid plate 95 to brake the brake rotor 91. Therefore, the case body 96 is provided with a spring (not illustrated) that biases the armature 93 towards the brake rotor 91.

In the brake unit 90, the electromagnet 94 generates an electromagnetic force by being energized by the battery 34 (FIG. 2), thereby attracting the armature 93 against the biasing force of the spring. As a result, the braking on the brake rotor 91 is released. When the electric power supply from the battery 34 to the electromagnet 94 is interrupted, for example, due to the operation of the two operation levers 22, 23 to the parking brake positions or turning off of a main switch (not illustrated) that turns on or off a system power supply of the vehicle, the armature 93 is pressed against the brake rotor 91 by the biasing force of the spring. As a result, the brake rotor 91 is sandwiched between the armature 93 and the lid plate 95, and thus the corresponding left wheel 12 is braked. At this time, the brake unit 90 on the right wheel 13 side is similarly operated to brake the right wheel 13. When the controller receives a detection signal indicating that both of the operation levers 22, 23 have been operated to the parking brake position, the control device energizes the left and right electromagnets 94 to brake the wheels 12, 13.

On the other hand, when the main switch (not illustrated) is turned on and the two operation levers 22, 23 and are operated to a position different from the parking brake position, for example, a neutral position or a travel position, the electromagnet 94 is energized by the battery 34 to attract the armature 93 and release the brake rotor 91, so that braking of the left wheel 12 is canceled. In this case, the brake unit 90 on the right wheel 13 side is also actuated in the same manner. Thus, braking of the right wheel 13 is also canceled. In this way, the vehicle can travel.

Here, a brake pedal (not illustrated) that can be operated by the driver's foot is provided in front of the driver's seat 21 of the vehicle. When the brake pedal is operated, regenerative braking occurs in the left and right electric travel motors 30, 31, and the rotation of each of the electric travel motors 30, 31 is stopped. On the other hand, when depression operation of the brake pedal is detected, the controller may cut off the energization to the electromagnet 94, and the left and right wheels 12, 13 may be braked by the brake unit 90.

In the above-described power transmission unit 41, the shaft end surface of the input shaft 60 on the electric travel motor 30 side is recessed, and the shaft spline hole 61 provided with the female spline portion 62 is formed in the recessed portion. The end of the motor shaft 32 is inserted into the shaft spline hole 61 in a state of being spline-engaged with the shaft spline hole 61. Accordingly, in the configuration in which the brake unit 90 is attached to the housing 44 on the side opposite to the electric travel motor 30, the length L1 (FIG. 4A) from the end surface of the housing 44 on which the electric travel motor 30 is mounted to the outer surface of the brake unit 90 can be shortened. Therefore, as illustrated in FIG. 3, the gaps d1, d2 between the wheels 12, 13 and the respective brake units 90 can be reduced as much as possible. That is, it is possible to improve the mountability of the power transmission units 41, 42 in a limited space of the vehicle. Therefore, it is possible to increase variation of the vehicle on which the power transmission units 41, 42 according to the present invention can be mounted.

In addition, since the length L1 can be shortened, as illustrated in FIG. 3, in a case where the left and right power transmission units 41, 42 are mounted such that the two left and right electric travel motors 30, 31 are disposed to face each other, even when the lengths of the electric travel motors 30, 31 in the left-right direction increase due to an increase in output, it is possible to secure a necessary interval between the electric travel motors 30, 31. As a result, a vehicle equipped with a high output electric travel motor can be easily realized.

The brake unit 90 is an electromagnetic brake unit 90, and the electromagnetic brake unit 90 includes electromagnets 94, 94a, the armature 93, the brake rotor 91, and the brake case 92, and can be separated from the input shaft 60. A male spline portion 61 provided outside an end on the protruding side of the input shaft 60 protruding from the housing 44 is inserted into a female spline portion 91b provided in the brake rotor 118 in a spline-engaged state.

A first thread hole group 100 and a second thread hole group 102 further inside than the first thread hole group 100 are formed in the brake attachment surface 47a of the housing. The electromagnetic brake unit 90 is detachably mounted using either the first thread hole group 100 or the second thread hole group 102 and covers the brake rotor 118.

Accordingly, for the housing 44, it is not necessary to manufacture and prepare a dedicated housing having a size varying depending on capacity of the brake unit 90 in advance. Even the brake unit 90 having a size varying depending on the capacity can be assembled to the common housing 44.

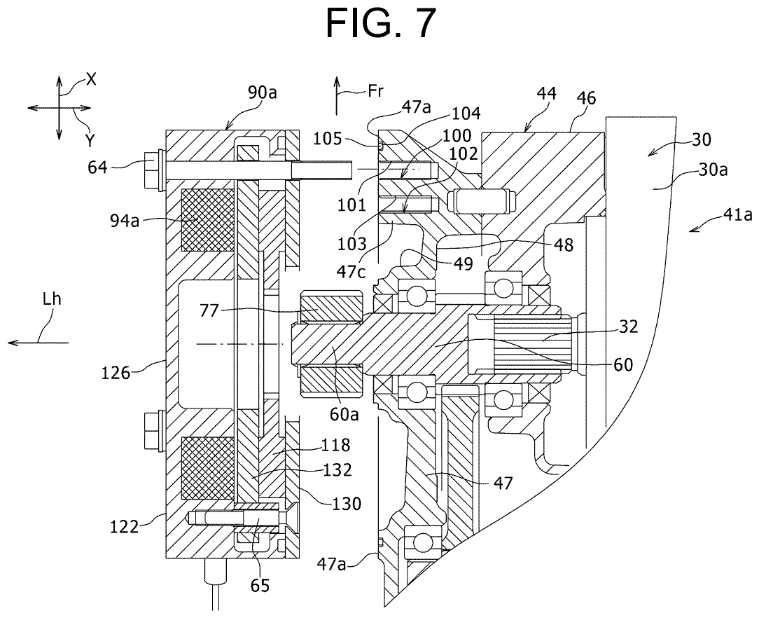

Although the case where the small brake unit 90 is assembled to the housing 44 by using the second thread hole group 102 has been described above, a brake unit 90a larger than the brake unit 90 may be assembled to the housing 44 by using the first thread hole group 100 as in a second embodiment which is another example of an embodiment illustrated in FIG. 7 described later.

The common seal member 105 that surrounds both the first thread hole group 100, and the second thread hole group 102 is provided between an inner end surface of the brake case 92 and the brake attachment surface 47a of the housing 44.

Accordingly, in a configuration in which the brake unit 90 selected from the brake units 90 having sizes varying depending on the capacity can be assembled to the common housing 44 by threading, and the sealing ability between the housing 44 and the brake case 92 can be ensured with the simple configuration.

When the electromagnetic brake unit 90 is the electromagnetic brake unit 90 threaded to the second thread hole group 102, a spacer 110 in contact with the seal member 105 is provided between the brake case 92 and the brake attachment surface 47a of the housing 44.

As a result, in a configuration in which brake units 90 with different sizes can be threaded to the housing 44, when a small brake unit 90 is assembled, the sealing ability between the housing 44 and the brake case 92 can be ensured by using the simple and uncomplicated spacer 110 with a thin-plate shape. Therefore, it is possible to improve the sealing ability between the housing 44 and the brake case 92 while suppressing an increase in component cost.

In the configuration according to the present example, as illustrated in FIG. 5, an air breather device 112 is provided above a front portion of the second member 47. In the second member 47, the air breather device 112 is attached to a vertical through hole (not illustrated) that communicates with the gear chamber S1 (FIG. 4A). The air breather device 112 is provided in order to prevent liquids such as water, dust, etc. from entering the housing 44 from the upper side and in order to allow air inside the gear chamber S1 to be sucked in and out of the housing 44 when lubricating oil in the gear chamber S1 expands. When an internal pressure of the gear chamber S1 is increased, the air is discharged to the outside of the housing 44 through the air breather device 112. In this way, it is possible to prevent an excessive increase in the internal pressure.

The first member 46 and the second member 47 each have a symmetrical shape about a center in the up-down direction. For example, as illustrated in FIG. 5, in the second member 47, a second through hole (not illustrated) is formed at a position that is aligned with the through hole, to which the air breather device 112 is attached, in the up-down direction. Since a plug is attached to a lower end portion of the second through hole, leakage of the oil from the gear chamber S1 is prevented.

As illustrated in FIG. 5, two holding recesses 99 for holding the fixed brake pad are formed on an outer surface of the second member 47 that is covered with the brake case 92. The holding recesses 99 are symmetrical with respect to the center in the up-down direction. The holding recess 99 corresponds to a holding hole. When combined with the mechanical brake unit, the fixed brake pad is held only in the upper holding recess 99 of the two holding recesses 99. Accordingly, each of the first member 46 and the second member 47 can use components with the same structure in common for each of the right wheel and the left wheel by reversing the up-down direction. When the second member 47 for the left wheel 12 is used for the right wheel 13, a plug is attached to the outer end of the rear through hole on the lower side, and the air breather device 112 is attached to the second through hole on the upper side. In the second member 47, the fixed brake pad is held only in the upper holding recess 99 of the two holding recesses 99. The holding hole may be a through hole passing through the second member 47 in the axial direction, instead of the holding recess.

### Second Embodiment

FIG. 7 is a diagram corresponding to FIG. 6 in a second embodiment. In a configuration according to this example, a brake unit 90a, which is an electromagnetic brake unit larger than the brake unit 90 used in the configuration of FIGS. 1 to FIG. 6, is used in combination with other elements of a power transmission unit 41a. In this example, the spacer 110 (FIG. 4B or the like) is not used.

Specifically, the brake unit 90a includes the brake rotor 118, an armature 132 disposed inside the brake case 122 so as to interpose the brake rotor 118 between the armature 132 and a fixing plate 130 described later, and an electromagnet 94a. The outer diameters of the brake case 122, the brake rotor 118, the armature 132, and the electromagnet 94a are larger than outer diameters of the brake case 92, the brake rotor 91, the armature 93, and the electromagnet 94 in the configuration of FIGS. 1 to FIG. 6, respectively. The outer diameter of the brake case 122 is substantially equal to the outer diameter of the annular portion 47b of the brake attachment surface 47a of the housing 44.

The brake unit 90a is threaded by using a plurality of bolts 64 threaded to the first thread hole group 100 further away from the input shaft 60 among the first thread hole group 100 and the second thread hole group 102 of the second member 47. At this time, the plurality of bolts 64 are threaded to the first thread hole group 100 by penetrating through holes provided at a plurality of positions of the case body 126 of the brake case 122, the armature 132, and the fixing plate 130.

Here, the seal member 105 attached to the seal groove 104 of the housing 44 is compressed by an end surface of the fixing plate 130 of the brake case 122. Therefore, according to the configuration of this example, unlike the configuration of FIGS. 1 to FIG. 6, since the outer diameter of the brake case 122 is substantially equal to the outer diameter of the brake attachment surface 47a of the second member 47, a spacer for coupling while ensuring the internal sealing ability is not required. In the present example, the other configurations and actions are the same as the configurations in FIGS. 1 to FIG. 6.

### Third Embodiment

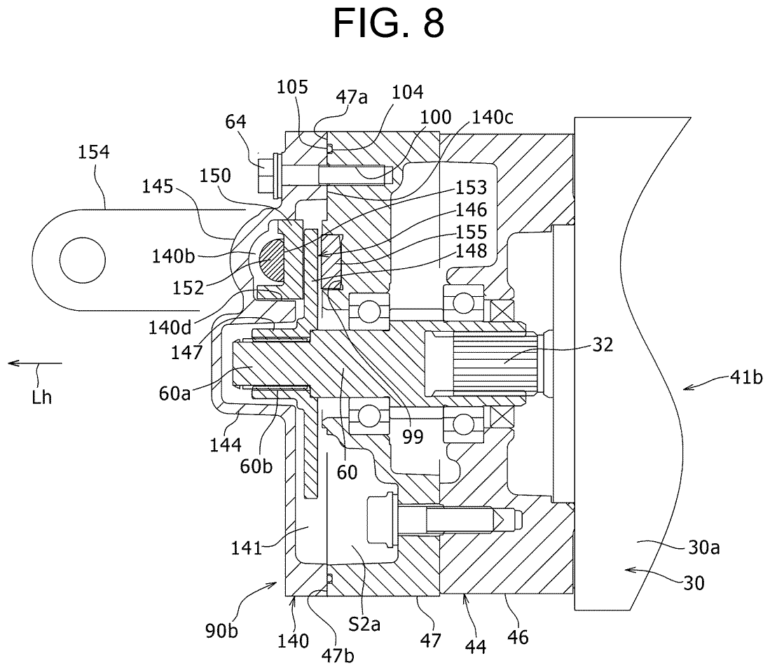

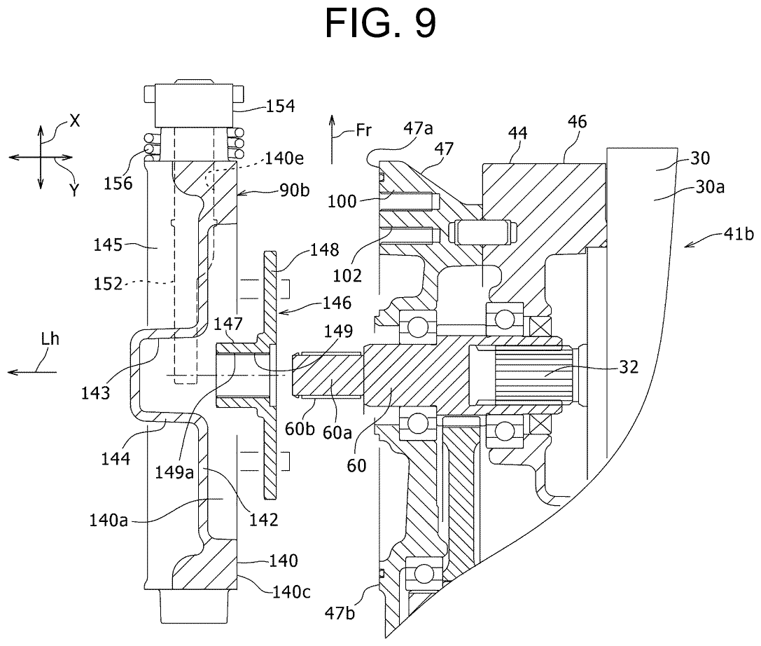

FIG. 8 is a diagram corresponding to FIG. 6 in a third embodiment. FIG. 9 is a diagram corresponding to the B-B cross section in FIG. 5 in the third embodiment. In the configuration of this example, unlike the configurations of the above-described examples, the mechanical brake unit 90b is used in combination with other elements of the power transmission unit 41b. In this example, as in the configuration of FIG. 7, no spacer is used between the brake case 140 and the housing 44.

As illustrated in FIG. 8, the mechanical brake unit 90b is a brake unit having a structure different from the structure of the electromagnetic brake unit and is a brake unit for mechanically braking the wheel at lower cost. The mechanical brake unit 90b includes a brake rotor 146, a movable brake pad 150 (FIG. 9) disposed to face an outer surface which is one side surface in the axial direction of the brake rotor 146, a brake operation shaft 152, and a brake case 140. The brake operation shaft 152 is configured to be able to press the movable brake pad 150 against the brake rotor 146 by manual operation. The movable brake pad 150, the brake rotor 146, and the brake operation shaft 152 are accommodated in the brake case 140 to form an assembly, and the assembly can be mounted on the housing 44.

The brake case 140 has a flat brake chamber 140a of which an inner end in the vehicle width direction is opened, and a recess 143 into which the second end 60a of the input shaft 60 is inserted is formed at a center of an inner surface of a bottom portion 142. A substantially cylindrical recess 144 is formed at the center of an outer surface of the bottom portion 142 so as to include the recess 143 therein. In order to constitute a durable wet brake, a part of the lubrication oil in the gear chamber S1 can flow into the brake chamber 140a.

As illustrated in FIG. 8, a recess 145 having a substantially semi-circular cross section and extending in the front-rear direction is formed in the outer surface of the bottom portion 142 so as to be connected to an upper side of the recess 144. A brake operation shaft arrangement space 140b communicating with the rotor arrangement space 140a is formed inside the recess 145. The outer diameter of an inner end surface 140c, which is an inner end surface of the brake case 140 in the vehicle width direction and abuts against the brake attachment surface 47a of the second member 47 of the housing 44, is substantially equal to the outer diameter of the brake attachment surface 47a.

The brake rotor 146 includes a cylindrical portion 147 at a center thereof, and a disc-shaped rotor body 148 formed on an outer circumferential surface of the cylindrical portion 147. A male spline portion 60b provided outside a second end 60a of the input shaft 60 protruding from the housing 44 is inserted into a spline hole 149 having a female spline portion 149a on an inner circumferential surface of the cylindrical portion 147 in a spline-engaged state so as to be relatively non-rotatable and axially slidable.

An outer end of the cylindrical portion 147 is arranged in the recess 143 of the brake case 140 together with the second end 60a of the input shaft 60. The rotor body 148 is arranged in the rotor arrangement space 140a. As illustrated in FIG. 9, the brake case 140 is connected to the housing 44, and the recess 143, the rotor arrangement space 140a, and the brake operation shaft arrangement space 140b form a brake chamber S2a.

As illustrated in FIG. 8, the movable brake pad 150 has a block shape having a substantially L-shaped cross section. In the brake operation shaft arrangement space 140b of the brake case 140, a holding recess 140d for holding the movable brake pad 150 is formed adjacent to the recess 145. The movable brake pad 150 can move in the axial direction of the brake rotor 146 while being held by the holding recess 140d.

The brake operation shaft 152 is rotatably supported in a state of extending in the vehicle front-rear direction with respect to the brake case 140 such that a tip portion of the brake operation shaft 152 is disposed in the brake operation shaft arrangement space 140b of the brake case 140. Accordingly, a through hole 140e which the brake operation shaft 152 penetrates and which rotatably supports the penetrating portion is formed on a front side of an upper portion of the brake case 140. On a front end of the brake operation shaft 152, brake lever 154 is fixed to a portion that protrudes outside the brake case 140. A lower end of the left operation lever 22 corresponding to the mechanical brake unit 90b among the two operation levers 22, 23 provided around the driver's seat is connected to a tip of the brake lever 154 via a wire or a link.

On an inner surface of the brake case 140, a holding recess (not illustrated) is formed at a position facing a tip of the brake operation shaft 152, and the tip of the brake operation shaft 152 is rotatably supported by the holding recess. A cam portion 153 having a substantially semi-circular cross section is formed on a tip portion including a portion facing the movable brake pad 150 of the brake operation shaft 152. The movable brake pad 150 is held by the the holding recess 140d so as to be movable in the axial direction of the brake rotor 146 between the above-described cam portion 153 and an outer surface of the rotor body 148.

A fixed brake pad 155 has a flat rectangular parallelepiped shape and is pressed against the brake rotor 146 in braking. In the second member 47 of the housing 44, a holding recess 99 is provided in a portion of the inner surface (right surface in FIG. 8) of the rotor body 158 facing the front upper portion. The fixed brake pad 155 is fixed to the holding recess 99.

The mechanical brake unit 90b is threaded to the housing 44 by using the first thread hole group 100 further away from the input shaft 60 among the first thread hole group 100 and the second thread hole group 102 of the housing 44, and a plurality of bolts 64 (FIG. 8 and FIG. 9) threaded to the first thread hole group 100. Here, the seal member 105 attached to the seal groove 104 of the housing 44 is compressed between a bottom surface of the seal groove 104 and the inner end surface 140c of the brake case 140 by the inner end surface 140c. Unlike the configuration of FIGS. 1 to FIG. 6, since the outer diameter of the brake case 140 is substantially equal to the outer diameter of the brake attachment surface 47a, it is not necessary to insert a spacer between the brake case 140 and the housing 44 in order to couple the brake case to the housing 44.

As illustrated in FIG. 5, the fixed brake pads 155 to be pressed against the brake rotor 146 are held in the upper holding recess 99 among the two holding recesses 99 formed in the end surface of the housing 44 on the brake unit side. Thus, the electromagnetic brake unit can be replaced with another mechanical brake unit 90b by using a part of the configuration using the electromagnetic brake unit. Further, instead of the mechanical brake unit 90b, another brake unit such as an electromagnetic brake unit can be threaded using the first thread hole group 100 or the second thread hole group 102, and the male spline portion 60b provided outside the input shaft 60 can be inserted into a female spline hole formed in a brake rotor of the other brake unit in a spline-engaged state.

Although the mechanical brake unit 90b provided in the left power transmission unit 41b has been described above, the brake unit provided in the right power transmission unit also has the same configuration as the left mechanical brake unit 90b except that the left-right relationship is reversed.

Furthermore, in an upper rear portion of the brake case 140, a second through hole (not illustrated) is formed at a position that is aligned with the through hole 140e in the front portion in the front-rear direction. The second through hole penetrates the brake case 140 in the front-rear direction in a manner to be symmetrical to the through hole 140e about a center in the front-rear direction. A plug is attached to an outer end portion of the second through hole and thereby prevents leakage of oil in the brake case 140. The brake case 140 has a symmetrical shape about the center in the front-rear direction. Thus, the same brake case 140 can be used for each of the right wheel and the left wheel by reversing the front-rear direction of the components in the same structures while maintaining the up-down relationship. In addition, by supporting the brake operation shaft 152 in the second through hole for the right wheel and attaching the plug on the outer end of the through hole 140e, the brake case 140 can be used in common for the right wheel and the left wheel by reversing only the front-rear relationship while maintaining the front-rear relationship.

When the two operation levers 22, 23 are operated to the parking brake position, the brake lever 154 rotates in the first direction. Consequently, the cam portion 153 provided on the brake operation shaft 152 also rotates, and thus the cam portion 153 pushes out the movable brake pad 150 from the holding recess 140d to the rotor body 148 to press the movable brake pad 150 against the rotor body 148. As a result, the left wheel 12 is braked. In this case, the brake mechanism on the right wheel 13 side is also actuated in the same manner. Thus, the right wheel 13 is also braked.

On the other hand, when each of the two operation levers 22, 23 is operated to positions different from the parking brake position, since the brake lever 154 rotates in the second direction, the cam portion 153 provided on the brake operation shaft 152 returns to the state illustrated in FIG. 8, and the cam portion 153 does not press the movable brake pad 150. As a result, the movable brake pad 150 moves away from the rotor body 148, and thus braking of the left wheel 12 is canceled. In this case, the brake mechanism on the right wheel 13 side is also actuated in the same manner. Thus, braking of the right wheel 13 is also canceled. In this way, the vehicle can travel.

As illustrated in FIG. 9, a coil spring 156 is provided between an outer surface of the brake case 140 and the brake lever 154. The coil spring 156 biases the brake lever 154 such that the brake lever 154 rotates in the second direction. In the present example, the other configurations and actions are the same as the configurations in FIGS. 1 to FIG. 6.

### Fourth Embodiment

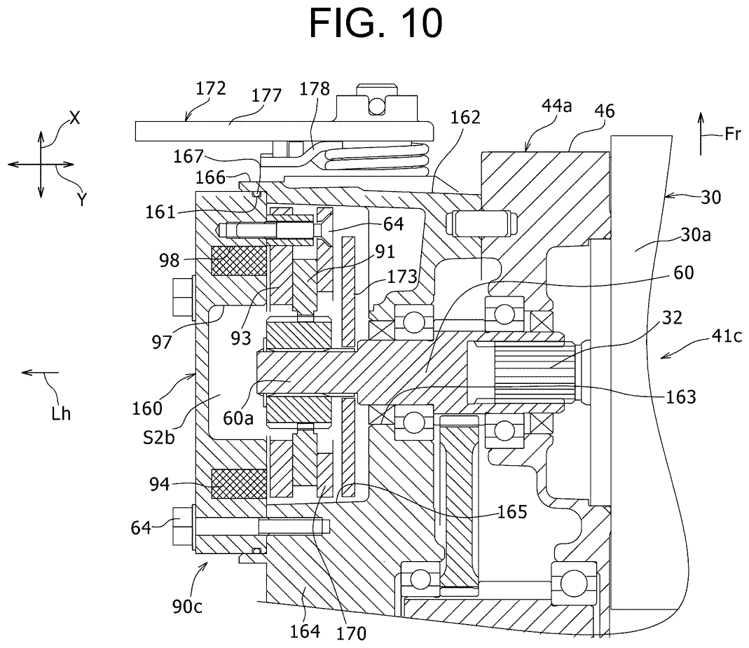

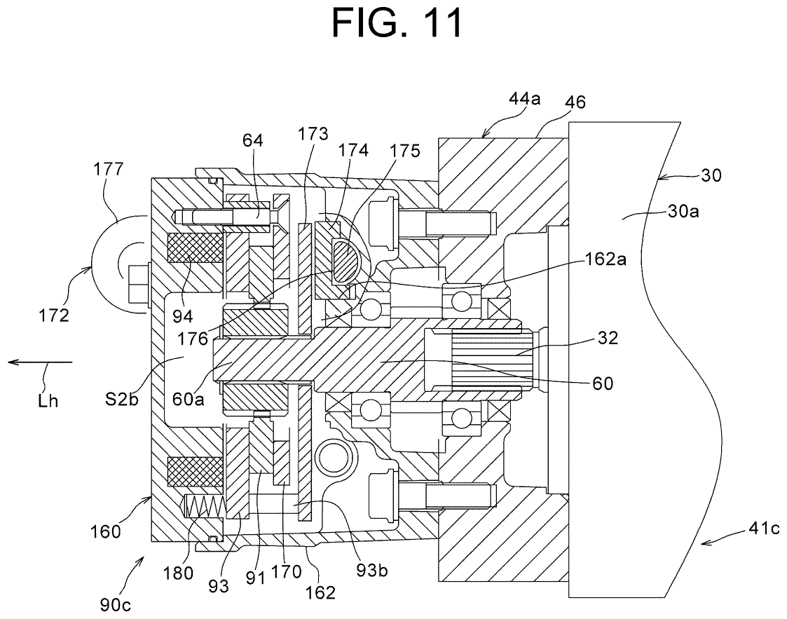

FIG. 10 is a modified diagram corresponding to FIG. 4B in a fourth embodiment. FIG. 11 is a diagram corresponding to FIG. 8 in the fourth embodiment. In a configuration according to this example, as in the configuration of each example illustrated in FIGS. 1 to FIG. 7, a brake unit 90c, which is an electromagnetic brake unit, is used in combination with other elements of a power transmission unit 41c.

In this example, a brake case 160 of the brake unit 90c has the first recess 97 that opens at the center of inner surface in the vehicle width direction and the second recess 98 in which the electromagnet 94 is disposed around the first recess 97, but the brake rotor 91 and the armature 93 are not accommodated in the brake case 160.

In an outer surface in the vehicle width direction of the second member 162 constituting the housing 44a, a wall portion 164 provided around a through hole 163 through which the input shaft 60 passes has a large thickness in the left-right direction, and a recess 165 that is open on an outer side in the vehicle width direction is formed inside the wall portion 164. The armature 93, the brake rotor 91, and the support plate 170 are accommodated in the recess 165. The support plate 170 is provided to appropriately manage a gap between the armature 93 and the brake rotor 91 in non-braking. The support plate 170 has an annular plate shape and is formed of a plate-shaped friction member such as a steel plate. The outer diameter of the support plate 170 is substantially equal to the outer diameter of the armature 93. The support plate 170 is connected to the brake case 160 by the plurality of threads 65 in a state where an outer surface of the support plate 170 faces an outer surface in the vehicle width direction of the brake rotor 91 and the brake rotor 91 can be sandwiched between the armature 93 and the support plate 170.

The brake case 160 described above abuts against outer surface of in the vehicle width direction of the wall portion 164 of the second member 162 in a state of being fitted to a cylindrical portion 166 formed in the outer surface of the wall portion 164. In this state, the plurality of bolts 64 penetrating the brake case 160 are threaded to the thread holes formed in the second member 162. In this way, the brake case 160 is fixed to the housing 44a. In this state, a seal member 167 made of an elastic material of rubber, plastic, or the like, such as an O-ring, is attached to an annular seal groove 161 formed in an outer circumferential surface of the brake case 160, thereby sealing an inside of the brake chamber S2b from the outside.

Further, the power transmission unit 41c according to this example is provided with a failure-time braking release mechanism 172 for mechanically releasing braking state by the brake unit 90c when a failure occurs in an electric system. The failure-time braking release mechanism 172 includes a pressing plate 173, a braking release pad 174 disposed to face an inner surface which is one side surface of the pressing plate 173 in the axial direction, a braking release shaft 175, and a braking release lever 177, and is provided in the second member 162. The braking release shaft 175 presses the braking release pad 174 against the pressing plate 173 to separate the armature 93 in contact with the pressing plate 173 from the brake rotor 91.

The pressing plate 173 is provided around the second end 60a of the input shaft 60. The pressing plate 173 is supported so as to be non-rotatable or rotatable with respect to the second end 60a of the input shaft 60. On the other hand, a plurality of column portions 93b protrude in parallel with the input shaft 60 at a plurality of circumferential positions on the inner surface in the vehicle width direction of the armature 93, and tips of the column portions 93b face and contact the outer surface of the pressing plate 173.

As illustrated in FIG. 11, the braking release pad 174 has a block shape with an L-shaped cross section. On the inner surface of the second member 162 facing the brake chamber S2b, a holding recess 162a for holding the braking release pad 174 is formed in a portion facing the front upper portion of an inner surface (right surface in FIG. 11) of the pressing plate 173. The braking release pad 174 can move in the axial direction of the pressing plate 173 while being held by the holding recess 162a.

The braking release shaft 175 is rotatably supported in a state of extending in the vehicle front-rear direction with respect to the second member 162 such that a tip portion thereof is disposed in the brake chamber S2b. Accordingly, a through hole (not illustrated) which the braking release shaft 175 penetrates and which rotatably supports the penetrating portion is formed on a front side of an upper portion of the second member 162. On a front end of the braking release shaft 175, braking release lever 177 is fixed to a portion that protrudes outside the second member 162. A braking release operation tool provided around the driver's seat is connected to a tip portion of the braking release lever 177 via a wire or a link.

On the inner surface of the second member 162, a recess (not illustrated) having a holding recess is formed at a position facing the tip portion of the braking release shaft 175. The tip portion of the braking release shaft 175 is rotatably supported in the holding recess. A cam portion 176 having a substantially semi-circular cross section is formed on a tip portion including a portion facing the braking release pad 174 of the braking release shaft 175. Accordingly, the braking release pad 174 is held in the holding recess 162a so as to be able to move the pressing plate 173 in the axial direction between the cam portion 176 and the inner surface of the pressing plate 173.

As illustrated in FIG. 10, a coil spring 178 is provided between the outer surface of the second member 162 and the braking release lever 177. The coil spring 178 is biased so that the braking release lever 177 rotates in a direction opposite to the braking release direction. Thus, as illustrated in FIG. 10, the pressing plate 173 and the support plate 170 are normally separated from each other.

Although the failure-time braking release mechanism 172 provided in the left power transmission unit 41c has been described above, the failure-time braking release mechanism provided in the right power transmission unit also has the same configuration as the left failure-time braking release mechanism 172 except that the left-right relationship is reversed.

When the braking release operation tool around the driver's seat is operated in the braking release direction, the braking release lever 177 rotates in the braking release direction. Accordingly, the cam portion 176 provided on the braking release shaft 175 also rotates, and thus the cam portion 176 pushes out the braking release pad 174 from the holding recess 162a to the pressing plate 173. Therefore, the braking release pad 174 is pressed against the pressing plate 173, and the armature 93 is pushed outward by the pressing plate 173 via the column portion 93a, whereby the armature 93 is separated from the brake rotor 91. As a result, braking of the left wheel 12 is released. In this case, the failure-time braking release mechanism on the right wheel 13 side also operates in the same manner.

According to a configuration of the present example, in the configuration in which a spring 180 provided in the brake case 160 applies the biasing force to the armature 93 in the direction in which the brake rotor 91 is sandwiched between the armature 93 and the support plate 170 to brake the left and right wheels, the braking force of the left and right wheels can be released by the braking release operation. Therefore, when a failure occurs in an electric system, the braking state by the brake unit 90c can be mechanically released. In the present example, the other configurations and actions are the same as the configurations in FIGS. 1 to FIG. 6.

Although the case where the braking release lever 177 is connected to the braking release operation tool by a link or the like has been described above, the braking release lever 177 may be configured not to be connected to operation tools around the driver's seat. In this case, when a failure occurs in the electric system, the driver can release braking forces of the wheels by operating the braking release lever 177 attached to the power transmission unit 41c on the lower side of the vehicle to the braking release side.

### Fifth Embodiment

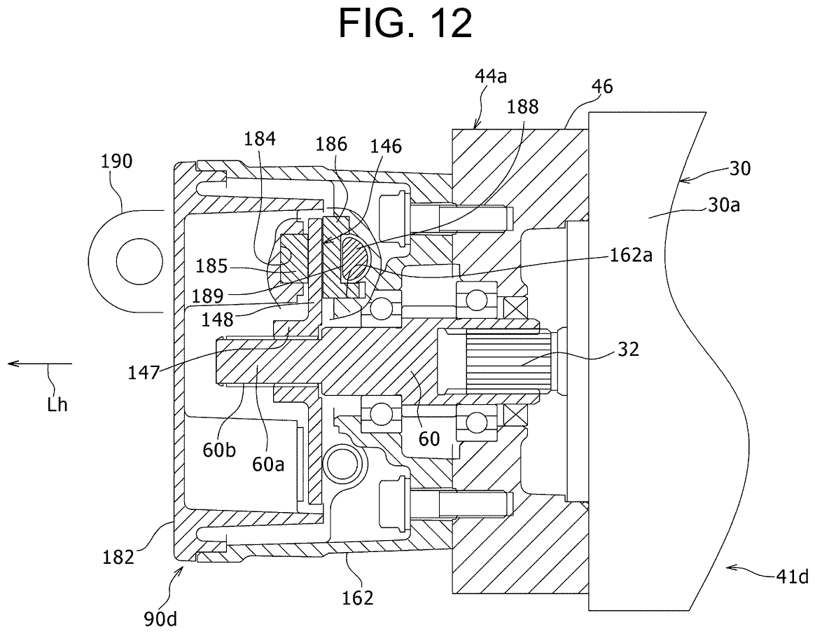

FIG. 12 is a diagram corresponding to FIG. 9 in a fifth embodiment. A configuration according to this example is obtained by replacing the electromagnetic brake unit with the mechanical brake unit 90d using a configuration common to a part of the configuration using the electromagnetic brake unit illustrated in FIG. 10 and FIG. 11.

In the power transmission mechanism 41d according to this example, a part of the failure-time braking release mechanism 172 used in the configuration of FIG. 10 and FIG. 11 constitutes a mechanical brake unit 90d. Specifically, the cylindrical portion 147 of the brake rotor 146 is spline-engaged with the male spline portion 60b provided on the outer circumferential surface of the second end 60a of the input shaft 60. In addition, the fixed brake pad 185 is held in a holding recess 184 formed on a front side of an upper portion on the inner surface of the brake case 182 in the vehicle width direction.

Then, the movable brake pad 186 is held in the holding recess 162a of the second member 162 so as to be movable in the axial direction of the brake rotor 146 such that the brake rotor 146 can be sandwiched between the fixed brake pad 185 and the movable brake pad 186. Further, the cam portion 189 is provided on the brake operation shaft 188 rotatably supported by the second member 162, and the cam portion 189 faces an inner surface of the movable brake pad 186. A brake lever 190 is fixed to a portion of the brake operation shaft 188 disposed outside the second member 162. The configuration including the brake lever 190, the brake operation shaft 188, the holding recess 162a, and the movable brake pad 186 are the same as the configurations including the braking release lever 177, the braking release shaft 175, the holding recess 162a, and the braking release pad 174 of the failure-time braking release mechanism 172 illustrated in FIG. 10 and FIG. 11, respectively.

As a result, according to the configuration of the present example, it is possible to easily realize the replacement with the mechanical brake unit 90d while using the configuration of the failure-time braking release mechanism 172. In the present example, the other configurations and functions are the same as the configuration of FIGS. 8, FIG. 9 or the configuration of FIG. 10, FIG. 11.

### Sixth Embodiment

The clutch mechanism 70 disclosed in FIG. 4A mentioned above is used to selectively disconnect the power input to the axle 120 when necessary. Since the brake unit 90 is positioned on the upstream side of power transmission relative to the clutch mechanism 70, if the clutch mechanism 70 remains in a non-power transmission state, the braking force of the brake unit 90 will not affect the axle 120 even if the brake unit 90 is activated.

Therefore, it is necessary to provide a fail-safe means that ensures the clutch mechanism 70 is always engaged when braking. This, however, increases the cost.

As an alternative, it is conceivable to move the position of the brake unit 90 from the input shaft 60 to the axle 120. However, since the axle 120 is subjected to large torque transmitted from the electric travel motor through the reduction gears, the brake unit would need to be enlarged to handle this large torque, which would also increase the cost.

In the sixth embodiment described later, the configuration aims to provide a reliable and cost-effective braking force to the axle 120 even if the clutch mechanism fails to engage. The same reference numbers are used for the same elements of the power transmission unit 41 described in the first embodiment, and detailed descriptions are omitted.

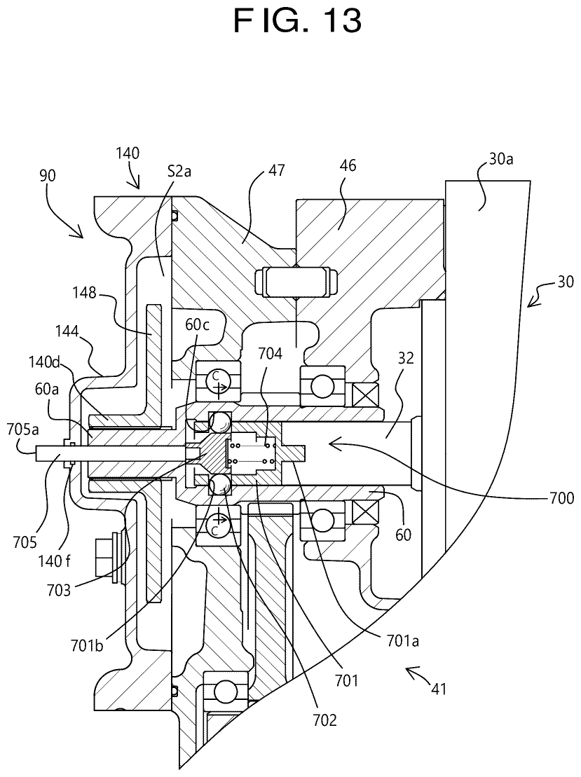

The power transmission unit 41 of the sixth embodiment, although not disclosed in FIG. 13, is configured by removing the clutch slider 71 of the clutch mechanism 70 shown in FIG. 4A from the axle 120 and connecting the output gear 84 to the axle 120 in a non-rotatable manner. Therefore, the input shaft 60 in FIG. 13 is always drivingly connected to the axle 120, which is not shown in the figure.

As shown in FIG. 13, a clutch mechanism 700 for engaging and disengaging the motor power to the axle 120 is interposed between the recess opened in the input shaft 60 and the motor shaft 32 inserted therein. That is, the clutch mechanism 700 is positioned on the upstream side of power transmission relative to the brake unit 90. The clutch mechanism 700 configured in the sixth embodiment applies a ball clutch type. The details are as follows.

The inner circumferential surface of the recess in the input shaft 60 does not have a female spline as disclosed in the first embodiment. Inside the recess, the motor shaft 32 and an extension shaft 701 coaxially adjacent to it are arranged. The extension shaft 701 has a cylindrical part as the main body and a bottom part continuously provided at one end of the cylindrical part. The outer surface of the bottom part facing the motor shaft 32 is integrally provided with a square-shaped protrusion 701a. By fitting into the locking groove opened at the end face of the motor shaft 32, the extension shaft 701 is connected to the motor shaft 32 in a non-rotatable manner.

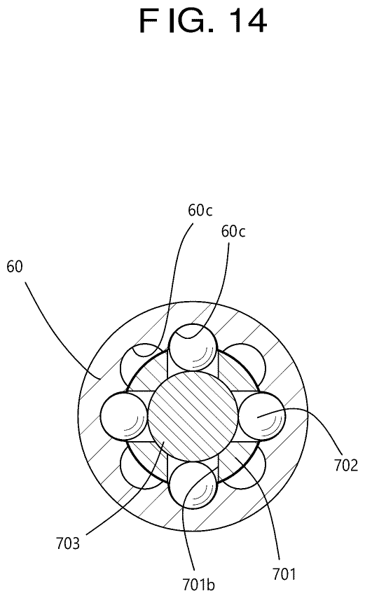

As shown in FIG. 14, a plurality of through holes 701b are formed in the cylindrical portion of the extension shaft 701 in the circumferential direction from the outer circumferential surface to the inner circumferential surface. Each of the holes 701b holds a ball 702 used as a power transmission member. The radial thickness of the cylindrical part of the extension shaft 701 is set to be approximately equal to the radius of the ball 702.

Plural ball engagement grooves 60c are provided on the inner circumferential surface of the recess in the input shaft 60 at positions corresponding to the holes 701b in the axial direction and in the circumferential direction.

Inside the cylindrical part of the extension shaft 701, a ball 702, a clutch slider 703, and a return spring 704 are arranged. The clutch slider 703 has a cylindrical ball pressing part with an outer diameter approximately equal to the inner diameter of the cylindrical part of the extension shaft 701. It also has a smaller diameter cylindrical ball housing part along the axial direction. The ball pressing part and the ball housing part are connected via a conical ramp part. The difference in the radial direction between the outer circumferential surface of the ball pressing part and the outer circumferential surface of the ball housing part is approximately equal to the radius of the ball 702. The return spring 704 is compressed between the end face of the ball pressing part and the bottom part of the extension shaft 701.

FIG. 13 shows the clutch mechanism 700 in a power transmission state, with the return spring 704 pushing the clutch slider 703. At this time, the end face of the ball housing part contacts the bottom of the input shaft 60, and the ball pressing part blocks the holes 701b. Therefore, the inner end of the ball 702 contacts the ball pressing part, and the outer end of the ball 702 protrudes from the outer circumferential surface of the extension shaft 701. The protruding outer end of the ball fits into the ball stopper 60c of the input shaft 60. As a result, the input shaft 60 and the extension shaft 701 are connected in a non-rotatable manner via the ball 702.

In this sixth embodiment, the ball 702 functions as the power transmission part to transmit the motor power to the input shaft 60.

Next, the mechanism for disconnecting the power transmission from the electric travel motor 30 to the input shaft 60 provided in the clutch mechanism 700 is configured as follows.

A shift rod 705 is attached to the end face of the ball housing part of the clutch slider 703. The shift rod 705 is positioned on the rotational axis of the extension shaft 701, and its operating end 705a extends outward through the second end 60a of the input shaft 60 and the recess 144 of the brake case 140.

A seal material 140f seals the gap between the outer circumferential surface of the shift rod 705 and the inner circumferential surface of the through-hole in the brake case 140, preventing oil accumulated in the brake chamber S2a from leaking out.

The shift rod 705 can slide axially along with the clutch slider 703 against the return spring 704 when an external force is applied to the operating end 705a. For example, a shift mechanism (not shown) is operatively connected to the shift rod 705. The shift mechanism includes a clutch operating tool such as a lever placed near the driver's seat, a wire, and a bell crank. One end of the bell crank is connected to the operating end 705a of the shift rod 705, and the wire extending from the clutch operating tool is connected to the other end of the bell crank arm.

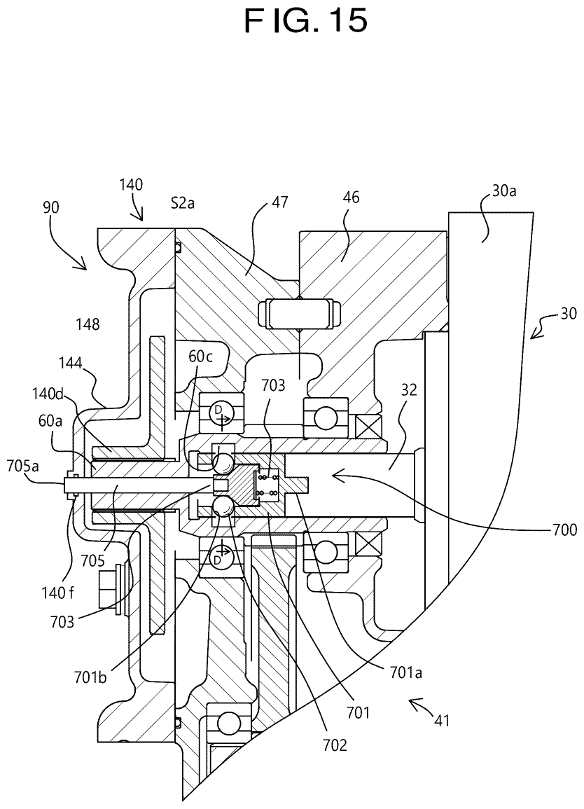

FIG. 15 shows a state in which the power transmission from the motor shaft 32 to the input shaft 60 is cut off by the clutch mechanism 700. This state is effective when, for example, towing a vehicle equipped with the power transmission unit of the present invention, and allows the wheels to rotate freely without any rotational resistance of the electric travel motors 30, 31. As described in the first embodiment, since the vehicle has a pair of power transmission units, when this vehicle is towed, both clutch mechanisms 700 are put into a power disconnection state.

When the driver operates the clutch operating tool, the shift mechanism activates, and the shift rod 705 is pushed into the brake case 140 against the return spring 704.

By pushing the shift rod 705, the ball pressing part of the clutch slider 703 moves toward the bottom of the extension shaft 701. As a result, the holes 701b in the extension shaft 701 are opened, releasing the balls 702. The inner end of the balls 702 then fits into the ball housing part of the clutch slider 703. The outer end of the balls 702 disengages from the ball stopper 60c and fits into the holes 701b in the extension shaft 701. Thus, the input shaft 60 becomes rotatable relative to the extension shaft 701 (motor shaft 32), allowing the axle 120 to rotate freely without the rotational resistance of the electric travel motor 30.

The clutch mechanism 700 is positioned on the upstream side of power transmission relative to the input shaft 60, and the brake unit 90 is on the downstream side of power transmission. If the brake unit 90 is activated with the operation levers 22, 23 described in the first embodiment in the parking position, the axle 120 can be braked regardless of whether the clutch mechanism 700 is in the power transmission state or the power disconnection state. Even if the clutch mechanism 700 fails and remains in the power disconnection state, the brake unit 90 can stop the rotation of the axle 120.

Although the brake unit 90 in the sixth embodiment uses a mechanical type, it may be an electromagnetic type as shown in FIG. 4A.

In regard to the configuration in each of the above-described examples, the description has been made on the configuration that the left and right wheels can be driven independently of each other, the left wheel is driven by the left electric travel motor, and the right wheel is driven by the right electric travel motor. However, the present invention can also be applied to a vehicle in which left and right wheels are driven by a common electric travel motor.

### REFERENCE SIGNS LIST

10 Vehicle
12 Left wheel
13 Right wheel
20c Coupling portion
21 Driver's seat
22, 23 Operation lever
30 Left electric travel motor
31 Right electric travel motor
32 Motor shaft
33 Male spline portion
41, 42, 41a, 41b, 41c, 41d Power transmission unit
44, 44a Housing
46 First section
47 Second section
47a Brake attachment surface
48 Wall portion
49 Cylindrical portion
60 Input shaft
60a Second end
60b Male spline portion
60d Recess
61 Shaft spline hole
62 Female spline portion
64 Bolt
65 Thread
66 Sleeve
72 Locking groove
73 Coil spring
74 Lever member
75 Lever shaft
76 Coil spring
77 Sleeve
78 Body
80a, 80b Gear mechanism
90, 90a, 90c (Electromagnetic) brake unit
90b, 90d Mechanical brake unit
91 Brake rotor
91b Female spline portion
92 Brake case
93 Armature
94, 94a Electromagnet
95 Lid plate
96 Case body
97 First recess
98 Second recess
99 Holding recess
100 First thread hole group
101 First hole
102 Second thread hole group
103 Second hole
104 Seal groove
105, 106, 107 Seal member
110 Spacer
118 Brake rotor
120, 121 Axle
122 Brake case
126 Case body
130 Fixing plate
132 Armature
140 Brake case
142 Bottom portion
143, 144, 145 Recess
146 Brake rotor
147 Cylindrical portion
148 Rotor body
149 Spline hole
150 Movable brake pad
152 Brake operation shaft
153 Cam portion
154 Brake lever
155 Fixed brake pad
156 Coil spring
160 Brake case
162 Second member
164 Wall portion
165 Recess
166 Cylindrical portion
167 Seal member
170 Support plate
172 Failure-time braking release mechanism
180 Spring
182 Brake case
700 Clutch mechanism
702 Ball
703 Clutch slider
705 Shift rod

1. A vehicle power transmission unit including an electric travel motor, an input shaft having a first end and second end, a gear mechanism, an axle, and a housing, wherein power from a motor shaft of the electric travel motor is transmitted to the input shaft, the gear mechanism, and the axle in this order, and the input shaft, the gear mechanism, and the axle are accommodated in the housing, the power transmission unit comprising,
a brake unit is mounted to the housing on a side opposite to the electric travel motor and is connected to the second end of the input shaft;
a recess is formed in an end surface of the first end of the input shaft on the electric travel motor side; and
an end of the motor shaft on the input shaft side is inserted into the recess; and
a power transmission part interposed between the recess and the end of the motor shaft.

2. The vehicle power transmission unit according to claim 1, wherein the power transmission part is a female spline formed in the recess and a male spline formed on the end of the motor shaft.

3. The vehicle power transmission unit according to claim 1, wherein the power transmission part is configured so that the recess of the input shaft and the end of the motor shaft can be connected and disconnected.

4. The vehicle power transmission unit according to claim 1, wherein the brake unit is an electromagnetic brake unit, and the electromagnetic brake unit includes an electromagnet, an armature, a brake rotor, and a brake case, and is attached so as to be separable from the input shaft;
the housing includes a brake attachment surface having a first thread hole group and a second thread hole group inward from the first thread hole group;
the second end of the input shaft protrudes outward from the brake attachment surface and is engaged with the brake rotor so as to be axially slidable and non-rotatable relative to the brake rotor; and
the electromagnetic brake unit is removably attached to the brake attachment surface using either the first thread hole group or the second thread hole group and covers the brake rotor.

5. The vehicle power transmission unit according to claim 4, further comprising,
a common seal member that surrounds both the first thread hole group and the second thread hole group is provided between an inner end surface of the brake case and a brake attachment surface of the housing.

6. The vehicle power transmission unit according to claim 5, wherein when the electromagnetic brake unit is the electromagnetic brake unit threaded to the second thread hole group, the brake case is provided with a spacer, and the seal member is compressed via the spacer.

7. The vehicle power transmission unit according to claim 5, wherein when the electromagnetic brake unit is the electromagnetic brake unit threaded to the first thread hole group, the seal member is compressed by an end surface of the brake case.

8. The vehicle power transmission unit according to claim 4, wherein one of the first thread hole group and the second thread hole group is used to allow a mechanical brake unit to be attached in place of the electromagnetic brake.

9. The vehicle power transmission unit according to claim 1, wherein the brake unit is a mechanical brake unit;
the mechanical brake unit includes a brake rotor, a movable brake pad disposed so as to face a side surface of the brake rotor, a brake operation shaft that presses the movable brake pad against the brake rotor, and a brake case, and is attached to the brake case so as to be separable from the input shaft in a state in which the movable brake pad, the brake rotor, and the brake operation shaft are accommodated in and supported by the brake case;
the housing includes a brake attachment surface;
the second end of the input shaft protrudes outward from the brake attachment surface and is engaged with the brake rotor so as to be axially slidable and non-rotatable relative to the brake rotor; and
the mechanical brake unit is removably attached to the brake attachment surface and covers the brake rotor.

10. The vehicle power transmission unit according to claim 9, wherein the brake operation shaft is supported in a state of extending in a front-rear direction of a vehicle with respect to the mechanical brake case.
